(19) United States
(12) Patent Application Publication
(10) Pub. No.: US 2023/0191858 A1
(43) Pub. Date: Jun. 22, 2023

(54) COUPLING DEVICE FOR COUPLING A TOWING VEHICLE TO A TRAILER

(71) Applicant: ZF CV Systems Global GmbH, Hannover (DE)

(72) Inventors: Daniel Pfefferkorn, Hannover (DE); Thomas Wolf, Barsinghausen (DE); Maximilian Dittloff, Hannover (DE)

(73) Assignee: ZF CV Systems Global GmbH, Hannover (DE)

(21) Appl. No.: 18/065,145

(22) Filed: Dec. 13, 2022

(30) Foreign Application Priority Data
Dec. 17, 2021 (DE) 10 2021 133 762.3

(51) Int. Cl. B60D 1/02

(52) U.S. Cl. CPC B60D 1/02

(57) ABSTRACT

A device for coupling a towing vehicle to a trailer vehicle of a vehicle combination, where the towing vehicle has a trailer coupling and the trailer vehicle has a drawbar. A measurement device is configured to measure forces and/or torques between the towing vehicle and the trailer vehicle has a two-part support with a first and second support components. The first support component has at least two measurement arms which extend radially and are symmetrically offset relative to one another. A strain gauge rosette is on each measurement arm. The second support component has counter-arms which extend radially and which correspond in number and arrangement to the measurement arms. The two support components can be attached firmly to one another and to the trailer coupling or to the drawbar. Also disclosed is a measurement-data capture and evaluation unit.

### RELATED APPLICATIONS

This application claims the benefit of and right of priority under 35 U.S.C. § 119 to German Patent Application no. 10 2021 133 762.3, filed on 17 Dec. 2021, the contents of which are incorporated herein by reference in its entirety.

### FIELD OF THE DISCLOSURE

The invention relates to a coupling device for coupling a towing vehicle to a trailer vehicle of a vehicle combination, in which the towing vehicle comprises a trailer coupling and the trailer vehicle comprises a drawbar that can be coupled to the trailer coupling, and which also comprises a measurement device for measuring forces and/or torques between the towing vehicle and the trailer vehicle. Furthermore, the invention relates to a measurement device for such a coupling device and a vehicle combination consisting of a towing vehicle and a trailer vehicle.

### BACKGROUND

The dynamic behavior and driving safety of a vehicle combination are influenced essentially by the movement of a towed trailer and the traction and thrust forces and dynamic transverse movements that occur during this. In particular, when the towing vehicle is pushed by the trailer vehicle coupled to it with a force of propulsion, there is a risk that the vehicle combination will jackknife at the coupling point and that driving safety and stability will be threatened. This must be avoided at all costs.

Coupling devices of such vehicle combinations, for example coupling devices with ball-and-socket couplings or bar-hitch couplings for the coupling of passenger cars or small pick-ups with solid drawbar trailers, must be able to transmit the coupling forces and bending moments produced during driving or maneuvering in all three spatial directions, and at the same time must ensure a secure connection between the two vehicles at all times.

Besides the continuous monitoring of the traction and thrust forces between the vehicles coupled to one another, a continuous determination of the forces and torques imposed on the coupling device can also be used for determining other important current information such as the articulation angle of the coupling, the load condition of the trailer or the tilt of the vehicle body. That information can be provided as regulating parameters for drive dynamics regulation systems in vehicle combinations, for example for electrical drive systems, for electronic brake systems, electronic stability controls, electronic level regulations or for driver-assistance systems. In view of the future electrification of drive-trains of motor vehicles, an accurate knowledge of coupling forces and coupling torques is gaining importance for the regulation of electrical drive systems in vehicle combinations.

However, it is still difficult, in the detection of the dynamics, forces and torques at the coupling point between the vehicles, to achieve a sufficiently high response sensitivity and high measurement precision for the regulation of such systems. Furthermore, the mechanical components of the coupling device must have high rigidity. The known measurement devices for the measurement of forces and/or torques between a towing vehicle and a trailer vehicle thus usually offer only limited accuracy, and/or measurements in only one or two spatial directions.

From DE 10 2014 223 654 A1 a coupling component is known, which has a hollow space in which at least one force sensor in the form of a strain gauge is arranged and fixed. The component can be a pendulum support, which is connected by means of a ball joint to a ball stud and is part of a system for the roll stabilization of a vehicle. In this case, in a partially hollow shaft section of the ball stud there is arranged a strain gauge with an electrical connection to the outside. Alternatively, the component can be a trailer coupling in the form of a coupling hook with a ball head, which has a hollow space inside the coupling hook in which at least one force sensor in the form of a strain gauge is arranged and fixed. The component serves essentially to determine a vertical supporting force.

EP 2 801 488 B1 discloses a trailer coupling for fitting onto a towing vehicle, with a coupling carrier which is arranged on a holder on the towing vehicle, and at the free end of which a coupling ball for attaching a trailer vehicle is arranged, and also comprising an evaluation device for determining at least one force that acts upon the coupling ball. The trailer coupling comprises a first force sensor, for example in the form of a strain gauge, for determining first force components that act upon the coupling ball, as well as a second force sensor, for example also in the form of a strain gauge, for determining second force components that act upon the coupling ball. The force sensors are arranged at various attachment points in such manner that the force components measured by one force sensor, for example in a geometrical axis that extends in the longitudinal direction of the vehicle, are measured more intensely to determine a traction or thrust force, than are the force components measured by the other force sensor, for example in a geometrical axis that extends in the transverse direction of the vehicle, to determine a pitching moment, or in a geometrical axis that extends perpendicularly to the longitudinal direction of the vehicle, to determine a supporting load. The evaluation device is designed to evaluate the force signals with their various intensities. The disadvantage of this arrangement is that the individual attachment locations of the various strain gauges cannot be simply transferred to other coupling devices, and this makes it more difficult to evaluate the information determined. In particular, the evaluation device requires a computation algorithm, for which numerous assumptions that cannot simply be transferred to other coupling devices have to be made, in order to interpret the force signals.

From US 2020/0 355 563 A1, a system for monitoring a trailer force is known with a coupling ball and a coupling ball stud which can be mounted on a vehicle drawbar, and with two or more strain gauges attached on different sides of the coupling ball stud. In addition, a control unit is provided in order to receive the signals generated by the strain gauges from the longitudinal and transverse forces acting upon the coupling ball, which are produced by compression, traction and oscillation forces of a trailer load connected to the coupling ball, and to calculate a load acting on the coupling ball and display it on a user interface of the control unit. The disadvantage of this is that the strain gauges pick up only longitudinal and transverse forces, but not force components directed downward or upward.

In the known measurement devices for the measurement of coupling forces, strain gauges are arranged on coupling shafts or coupling hooks. These measurement devices are provided exclusively for measuring coupling forces on ball-head couplings. In contrast, there is a need for a measurement device in which the force sensors can be arranged uniformly on the towing vehicle side on trailer couplings of various designs, as for example ball-head couplings or bar-hitch couplings, and can likewise be fitted onto drawbars on the trailer side.

### SUMMARY

Against this background, the purpose of the present invention is to propose an improved coupling device of the type mentioned, whose measurement device has sensitive response behavior and high measurement accuracy, and which can nevertheless be produced simply and can be adapted or fitted simply to coupling devices of various designs. In particular, the measurement device should be suitable for use with coupling devices of passenger car and small pick-up truck combinations consisting in each case of a towing vehicle and a trailer vehicle.

This objective is achieved with a coupling device having the characteristics disclosed herein. Advantageous design features and further developments of this coupling device will be apparent in light of the present disclosure. In addition, a measurement device according to the invention and a vehicle combination equipped with the coupling device and the measurement device are disclosed.

Accordingly, the invention relates to a coupling device for coupling a towing vehicle to a trailer vehicle of a vehicle combination, in which the towing vehicle comprises a trailer coupling and the trailer vehicle comprises a drawbar that can be coupled to the trailer coupling, and which also comprises a measurement device for measuring forces and/or torques between the towing vehicle and the trailer vehicle.

To achieve the stated objective, in relation to the provision of a coupling device, the invention envisages that the measurement device comprises a two-part support with an elongated first support component in the form of a sensor carrier and an elongated second support component designed as a counterpart for the first support component, the first support component having at least two measurement arms that extend radially at a first end of the first support component, the measurement arms of the first support component being arranged symmetrically offset relative to one another, with a strain gauge that acts as a force sensor arranged on each of the measurement arms of the first support component, the second support component having counter-arms that extend radially at a first end of the second support component and that correspond in number and arrangement with the measurement arms of the first support component, the two support components with their first ends facing toward one another being able to be connected firmly to one another by connecting the measurement arms to their respectively associated counter-arms, the first support component with its end facing toward the towing vehicle being able to be connected firmly to coupling means on the trailer side, the second support component with its end facing toward the trailer vehicle being able to be connected firmly to the drawbar, the measurement device comprising an electronic measurement-data capturing and evaluating unit that is or can be electrically connected to the strain gauge rosettes, the measurement device being arranged completely or partially on the two-part support directly on or a distance away from it, the measurement device being designed to capture and evaluate deformations of the coupling device in all three spatial directions caused by forces and/or bending moments, with electrical signals correlated with strain variations of the strain gauge rosettes, and the measurement device comprising an electronic circuit and/or a computer program with an algorithm by means of which, from the sensor signals captured, the coupling forces, coupling bending moments and/or their components are able to be determined according to size and direction and in their time sequence and to be made available for further processing.

This arrangement produces a coupling device which enables the determination of coupling forces and coupling torques between a towing vehicle and a towed vehicle in all three spatial directions, and thereby achieves high precision and good time resolution with sensitive response behavior. This is based on the recognition that the use of a measurement device with strain gauge rosettes, in combination with a mechanical structure in the form of measurement arms on which the strain gauge rosettes are arranged symmetrically in such manner that mechanical deformations of the coupling device in all directions can be transmitted in a balanced manner to the strain gauge rosettes, enables a very accurate measurement of coupling forces in all three spatial dimensions.

The precise and highly time-resolved measurement of coupling forces and coupling torques can be used to good advantage in numerous applications in the drive-dynamical regulation of a vehicle combination and for the regulation of driver-assistance systems and systems for automated driving. Some applications are the adjustment of the braking force of an electronic braking system and an electronic stability control, a pitch angle and inclination angle prediction, the preventive damping-down of trailer oscillations and/or the avoidance of coupling overloads, and the determination and monitoring of the weight of a vehicle.

In simple application cases, three-dimensional evaluation is not necessary and only one coupling force component, for example the traction or thrust force in the travel direction, is taken into account for controlling a braking force. However, in any event the coupling device has the potential to determine the coupling forces between the towing vehicle and the trailer vehicle in all three spatial directions with the help of a measurement device based on a support with strain gauge rosettes.

Since the measurement arms of the support are arranged symmetrically offset relative to one another, the fitting direction of the support can be varied. Expressed in other words, the functionality of the sensor elements does not depend on the assembly direction. This structure, in particular, enables the use of the measurement device in the horizontal or vertical direction relative to the travel direction of the vehicle, and basically also in any other direction. The sensor signals of the sensor elements supply accurate three-dimensional coupling force information in any assembly direction. Accordingly, the support can be fitted into the coupling device, advantageously adapted to the respective assembly situation on the vehicle combination as regards the fitting space available, the deflectability and the necessary mechanical rigidity of the coupling connection. This also enables relatively simple retrofitting of existing coupling devices of the said type with a support according to the invention.

Furthermore, the fitting location of the support onto the coupling device can be chosen flexibly. Thus, depending on the existing structural circumstances the support can be arranged on the trailer coupling of the towing vehicle or on the drawbar of the trailer. This makes possible a relatively simple and cost-saving integration into various existing coupling devices.

A further advantage of the coupling device according to the invention is its success-promising use in vehicle combinations with electric drive-trains. Above all, in view of the increasingly frequent introduction of electrically powered trailer vehicles expected in times to come, both in utility vehicle combinations and also in passenger car combinations, the demands for an efficient and safe braking force regulation system are increasing. For that, as accurate a knowledge as possible of the coupling forces at the coupling point between the towing vehicle and the towed vehicle is required. Determination of the actual weight loading the coupling device is also important. Moreover, an accurate knowledge of the coupling forces can considerably facilitate the manual maneuvering of electrically drivable trailers, for example caravans with an electric drive of their own. This can be achieved advantageously with the coupling device according to the invention.

The measurement device consists of a two-part mechanical component and an electronic component. The two-part mechanical component is a two-part support, wherein a first support component comprises a plurality of measurement arms and a second support component has an equal number of counter-arms orientated in the same way. After the mechanical connection of the measurement arms to the associated counter-arms, the two support components are connected firmly to one another. To determine the three-dimensional forces and torques acting upon the coupling device, the two-part support with its plurality of measurement arms and counter-arms is mounted fixed on the trailer coupling or on the drawbar of the trailer vehicle. When the two support components of the coupling device are frictionally joined to one another, the measurement arms react with longitudinal and/or torsional strains to the reversible deformations of the trailer coupling or the drawbar brought about by mechanical stresses during driving or maneuvering operations of the vehicle combination.

The electronic component is a measurement-data capturing and evaluation unit, which is or can be electrically connected to the strain gauge rosettes mentioned. Accordingly, a strain gauge rosette is arranged on each measurement arm. The longitudinal and/or torsional strains of the measurement arms are transmitted to the strain gauge rosettes. The measurement-data capturing and evaluation unit can receive the electric sensor signals generated by the strain gauge rosettes when they undergo strains produced by deformations of the coupling device caused by forces and/or bending moments, and with the help of a suitable electronic circuit and/or a computer program with an algorithm, can determine from those signals the coupling forces, coupling bending moments and/or their components acting on the coupling device by size, direction and time sequence and make them available for further processing in a control unit of the vehicle for various applications, such as for the regulation of an electronically controllable trailer brake system.

The measurement-data capture and evaluation unit can be arranged directly on the support. For example, for that purpose a small, rigid printed circuit board or a foil-type printed circuit can be positioned on that part of the support on which the individual strain gauges are arranged. On the said printed circuit electrical conductors electrically connected to the individual strain gauges are interconnected with one another. The sensor signals generated by the strain gauges can then be digitalized by means of an A/D converter and amplified. Thereafter, in a microprocessor embedded in the printed circuit the required coupling force information can be calculated from the sensor signals. Finally, these signals can be sent by wired or wireless means to a control unit, for example to a brake control unit. The coupling force information can thereby advantageously be determined at the support component mentioned. Preferably, the measurement-data capture and evaluation unit are arranged on the support component on the towing vehicle side.

Alternatively, it is possible to send the sensor signals of the strain gauge rosettes to a microprocessor arranged remotely from the support, and only there calculate the coupling force information. In that way the microprocessor can be integrated in another control unit. Moreover, in that way it is simpler to protect the measurement-data capture and evaluation unit from harmful environmental influences.

In accordance with a further development of the invention, it can be provided that on each measurement arm of the first support component, in the area of a free end, in each case one of three strain gauge rosettes consisting of strain gauges is arranged, in each case with a central strain gauge orientated in the direction of a notional geometrical longitudinal axis of the measurement arm, and two strain gauges adjacent to the central strain gauge each arranged at an angle of 45°.

A single strain gauge could only detect an electric signal corresponding to a strain of the measurement arm in a main strain measurement direction. In that way only a one-dimensional projection, i.e. only part of the actual strain of the measurement arm concerned could be measured. In contrast, a strain gauge rosette with three strain gauges arranged at an angle to one another produces a plurality of electric signals and enables a reconstruction of the actual three-dimensional strain of the measurement arm, and thus the measurement of forces and torques in all directions.

At the measurement arms of the support the deformation of the coupling device or the trailer device can have different effects, so that the measurement arms experience measurable strain differences and the strain gauge rosettes undergo different strains. From the electric signals of the strains of the strain gauges and from the strain differences of the individual arms, after a prior calibration of the measurement device that takes into account the strength characteristics of the material of the support, i.e. its modulus of elasticity and its Poisson's ratio, conclusions can be drawn about the actual forces and torques affecting the coupling device, by size and direction.

For the evaluation of the electric signals produced from the strain variations of the strain gauges in the strain gauge rosettes, known mathematical methods can be called into play. For this purpose the strain gauge rosettes are electrically interconnected with one another in a suitable manner so that from the strain-induced electrical resistance changes of the individual strain gauges direction- and size-dependent separate electric signals can be obtained as input parameters for the calculation of the force components required.

Accordingly, a precise reconstruction of the amplitude and direction of forces and torques acting upon the coupling device can take place in accordance with the principle of vectorial addition of the strain measurement signals of the individual component strain gauges of the strain gauge rosettes. Algorithms and electronic circuits for evaluating strains from strain gauge rosettes are already known. For example, reference can be made to DE 16 48 385 A, in which a strain gauge rosette computer for a strain gauge rosette with three strain gauges arranged at an angle to one another, is described. A support with a plurality of strain gauge rosettes on a plurality of measurement arms according to the invention can be evaluated by these means in order to obtain the desired vectorial information about the coupling forces and coupling bending moments acting on the coupling device.

According to a first embodiment of the two-part support, it can be provided that the support is in the form of a two-arm arrangement, wherein the first support component comprises a radially extending first measurement arm and a radially extending second measurement arm which are orientated diametrically opposite one another, and the second support component comprises two correspondingly designed and arranged counter-arms.

Such a two-arm arrangement satisfies requirements in which only the coupling force in a preferred direction, namely laterally, vertically or longitudinally relative to the longitudinal direction of the vehicle, is to be determined. In this case the force components in a plane can be determined and from that the resulting coupling force in the desired direction can be calculated. For example, in that way the traction force or thrust force on a caravan combination or the weight imposed on a trailer coupling can be determined reliably, but not both at the same time. This minimal version has the advantage that its structure is compact and light, and it is simple and inexpensive to produce.

In a second embodiment of the two-part support, it is provided that the support is in the form of a three-arm arrangement, wherein the first support component comprises three radially extending, namely a first to a third measurement arms, which are arranged relative to their adjacent measurement arms in each case offset by an angle of 120°, and the second support component has three correspondingly designed and arranged counter-arms.

This arrangement enables a reliable complete measurement of coupling forces and coupling torques in all three spatial directions. With three measurement arms, however, the two-part support has a space-saving and weight-saving structure and is relatively inexpensive to produce.

According to a third embodiment of the two-part support, it can be provided that the support is a four-arm arrangement, wherein the first support component comprises four radially extending measurement arms, namely a first measurement arm to a fourth measurement arm, which are arranged relative to their adjacent measurement arms in each case offset by an angle of 90° in relation to one another, and the second support component comprises four correspondingly designed and arranged counter-arms.

This four-arm arrangement also enables a reliable and complete measurement of coupling forces and coupling torques in all three spatial directions, wherein by comparison with a three-arm arrangement greater accuracy can be achieved. The four-arm arrangement represents a compromise between, on the one hand, the demand for great measurement precision, and on the other hand, a compact and inexpensive structure, and the four-arm arrangement is advantageously suitable as a standard version for many applications.

In a fourth embodiment of the two-part support, the support is made as a six-arm arrangement, wherein the first support component comprises six radially extending measurement arms, namely a first measurement arm to a sixth measurement arm, each offset by an angle of 60° relative to one another, and the second support component comprises six correspondingly designed and arranged counter-arms. A six-arm arrangement enables the measurement of all coupling forces and coupling torques in every direction with very great precision.

According to other further developments of the invention, it is provided that in addition, one or more strain gauge rosettes are arranged on one or more of the counter-arms of the second support component. By virtue of a diametrically opposite arrangement of two strain gauge rosettes on the measurement arms and the associated counter-arms, the precision of the measurements can be increased, and the plausibility of the measured values determined can be checked. Thanks to such an arrangement the number of measurement arms is doubled since the counter-arms are also effective as measurement arms. For example, with such a three-arm arrangement a precision at least approximately comparable to that of a six-arm arrangement can be achieved, advantageously with a weight-saving and space-saving structure.

The invention also relates to a measurement device for the measurement of forces and/or torques between a towing vehicle and a trailer vehicle of a vehicle combination, which is constructed in accordance with at least one of the device claims or in accordance with at least one of the above-mentioned features.

Finally, the invention relates to a vehicle combination such as a passenger car-caravan train or a small pickup-drawbar-trailer train, with a coupling device for coupling the towing vehicle to the trailer vehicle, which is constructed in accordance with at least one of the device claims or in accordance with at least one of the above-mentioned features.

A coupling device having the features of the invention can basically be used in any vehicle combination with a trailer coupling and a drawbar. In particular, it is provided and can be advantageously used for vehicle combinations with trailers weighing up to a total trailer weight of 12,000 kg, but is not limited to that

### BRIEF DESCRIPTION OF THE DRAWINGS

Below, the invention will be explained in greater detail with reference to a number of example embodiments illustrated in the attached drawings, which show:

FIG. 1: A schematic view of a coupling device with a measurement device having the features of the invention, and with a first embodiment of a two-part support, viewed from the side,

FIG. 2: A perspective view of the two-part support shown in FIG. 1,

FIG. 3: A perspective view of a first support component of the two-part support, with two measurement arms as in FIGS. 1 and 2,

FIG. 4: A detailed view of a measurement arm of the first support component of the two-part support of the coupling device, with a strain gauge rosette,

FIG. 5: A detailed view of the strain gauge rosette shown in FIG. 4,

FIG. 6: A perspective view of a two-part support with three measurement arms, according to a second embodiment of the invention,

FIG. 7: A view from above, of the support with the three measurement arms as shown in FIG. 6,

FIG. 8: A side view of the support with the three measurement arms as shown in FIG. 6,

FIG. 9: A perspective view of a two-part support with four measurement arms according to a third embodiment of the invention,

FIG. 10: A perspective view of the first support component of the two-part support with four measurement arms as shown in FIG. 9,

FIG. 11: A side view of the support with the four measurement arms as shown in FIG. 9,

FIG. 12: A perspective view of a two-part support with six measurement arms according to a fourth embodiment of the invention,

FIG. 13: A perspective view of the first support component of the two-part support with six measurement arms, as shown in FIG. 12, and

FIG. 14: A side view of the two-part support as shown in FIG. 12.

Various structural elements in the figures are identical, so these are denoted by the same indexes.

### DETAILED DESCRIPTION

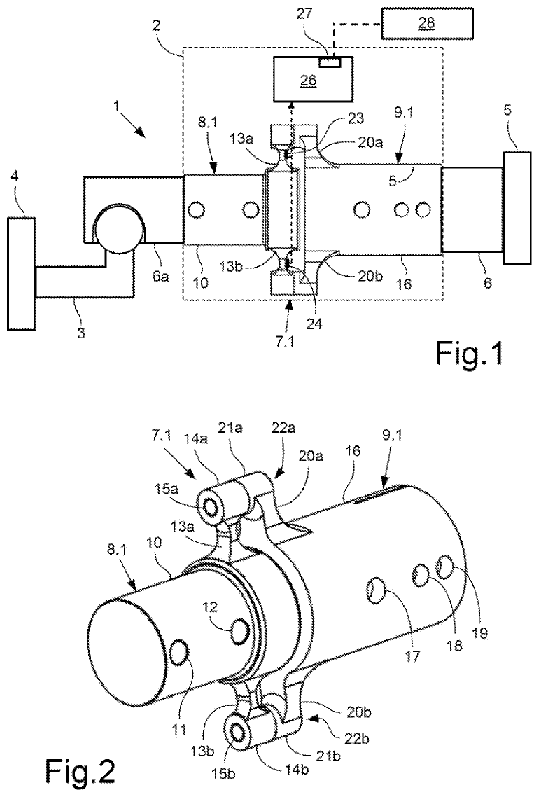

Accordingly. FIG. 1 shows a coupling device 1, which serves for the detachable formation of a vehicle combination and for measuring coupling forces and/or coupling torques. This vehicle combination consists, for example, of a light towing vehicle 4 and a light trailer vehicle 5. The said vehicle combination, however, can also be a passenger car-caravan combination. The coupling device 1 comprises a measurement device 2 for measuring the coupling forces and/or coupling torques acting upon the drawbar 6 and on the one trailer coupling 3 of the towing vehicle 4.

In the first example embodiment shown in FIGS. 1, 2, and 3, the measurement device 2 comprises a two-part support 7.1 in the form of a two-arm arrangement, with a first support component 8.1 and a second support component 9.1. The first support component 8.1 has a first central basic portion 10, in this case in the form of a tube. In the first basic portion 10 there are at least two holes 11, 12 which serve to allow the insertion of fixing screws by means of which the said first basic portion 10 can be attached firmly to coupling means 6a of an ordinary ball-head coupling on the trailer side. The trailer-side coupling means 6a of the ball-head coupling is detachable in a known manner and can be articulated to a ball head of a trailer coupling 3 of the towing vehicle 4.

The second support component 9.1 comprises a second central basic portion 16, in this case also in the form of a tube. However, the first basic portion 10 and the second basic portion 16 can also have a rectangular, U-shaped or other cross-section geometry. In the second basic portion 16 three holes 17, 18, 19 are formed, which are used for a firm screw connection to the drawbar 6 of the trailer vehicle 5. Instead of the said screw connections, however, the two basic portions 10, 16 can also be welded to the trailer-side coupling means 6a or to the drawbar 6. However, a screw connection has the advantage that retrofitting is possible on an already existing trailer vehicle design. In the assembled condition the two-part support 7.1 is arranged fixed between the drawbar 6 of the trailer vehicle 5 and the trailer-side coupling means 6a in order to perform its measurement tasks, in such manner that the drawbar 6 can be coupled onto the trailer coupling 3 of the towing vehicle 4 as has been usual so far.

At this point it should be said that the coupling device 1 is not limited to a particular type of structure. Thus, with a passenger car-caravan combination, although a ball-head coupling is provided, in the case of a utility vehicle a bar-hitch coupling or a bolt coupling can be used instead. In both cases the two-part support 7.1 can be fitted on the trailer side or on the towing vehicle side, on the one hand in order to articulate the towing vehicle to a trailer vehicle and on the other hand to measure the forces and/or torques acting in the coupling area.

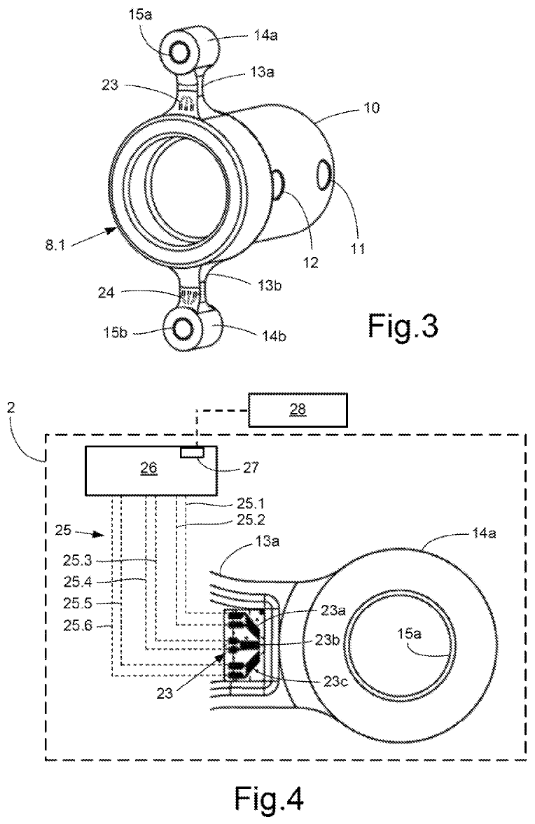

As illustrated particularly clearly in FIGS. 2 and 3, at an axial end of the basic portion 10 of the first support component 8.1 remote from the towing vehicle two measurement arms 13a, 13b extend diametrically opposite one another. At their respective radially outer ends the first measurement arm 13a and the second measurement arm 13b in each case have an axially projecting eyelet 14a. 14b with respective through-bores 15a. 15b extending with their axes parallel to the longitudinal direction of the first basic portion 10. The through-bores 15a, 15b serve to enable connection of the two measurement arms 13a, 13b to respective associated counter-arms 20a. 20b of the second support component 9.1 of the two-part support 7.1, for example by means of a screw connection. Starting from the end of the basic portion 16 of the second support component 9.1, first and second counter-arms 20a, 20b extend radially and diametrically opposite one another, the radially outer ends of which also have axially projecting eyelets 21a, 21b with axis-parallel through-bores 22a, 22b.

FIG. 2 shows the two-part support 7.1 in a condition prepared for assembly, wherein the two essentially tube-shaped support components 8.1, 9.1 are positioned against one another with their arm-supporting axial ends 13a and 13b and the counter-arms 20a, 20b directed in line with one another. FIG. 2 shows the first support component 8.1 designed as a sensor carrier as a single component, looking at its back side that faces away from the towing vehicle which in the assembled condition faces toward the second support component 9.1 or the drawbar 6. In the figure it can be seen that on each of the two measurement arms 13a, 13b, close to the eyelets 14a, 14b mentioned, in each case a strain gauge rosette 23, 24 is arranged.

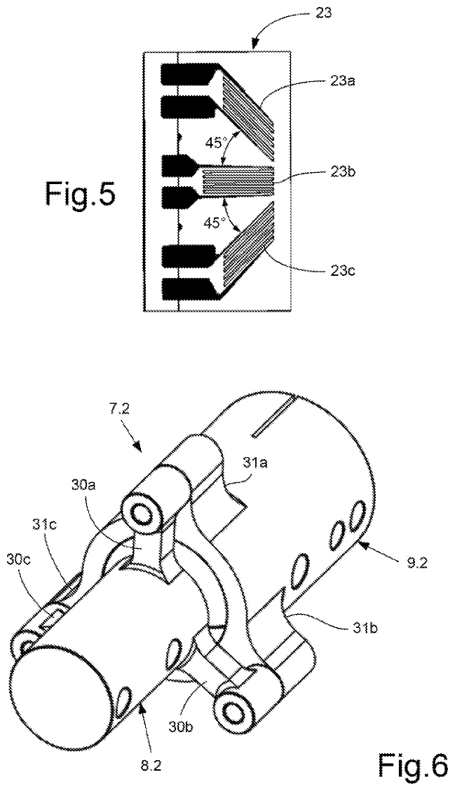

FIGS. 4 and 5 show in detail, as an example, the structure of the first strain gauge rosette 23 on the first measurement arm 13a. The strain gauge rosette 23 is arranged as close as possible to the eyelet 14a of the measurement arm 13a and is connected firmly, for example in a material-bonded manner, to the material of the measurement arm 13a. The strain gauge rosette 23 consists of a central strain gauge 23b and two further strain gauges 23a, 23c, which are arranged to the right and left of it in each case at an angle of 45° to the central strain gauge 23b. The three strain gauges 23a. 23b and 23c are in each case connected by two electrically conducting cores 25.1, 25.2, 25.3, 25.4, 25.5, 25.6 of a six-core electric line 25 to a measurement-data capture and evaluation unit 26. The second strain gauge rosette 24 (not shown here), which is arranged on the second measurement arm 13b, is of identical form and correspondingly connected to the measurement-data capture and evaluation unit 26 by a further six-core electric line.

In the other figures, explicit representations of further strain gauge rosettes are omitted. The only important thing is that in all the further example embodiments described in what follows, such a strain gauge rosette is arranged on each measurement arm and is electrically connected to the measurement-data capture and evaluation unit. A possible further development is the additional arrangement of such strain gauge rosettes on one or more of the aforesaid counter-arms for the purpose of increasing the precision of the determination of the coupling forces and coupling torques still more.

The measurement-data capture and evaluation unit 26 comprises electronic and software technological means, already known as such, by means of which the electrical signals correlated with the strain variations of the strain gauge rosettes 23, 24 can be evaluated in order to determine the forces and torques to which the coupling device 1 is exposed during trailer operation. For example, the measurement-data capture and evaluation unit 26 can be arranged on a printed circuit board, in turn arranged in a protected area of this two-part support 7.1.

In addition, the measurement-data capture and evaluation unit 26 comprises an electrical or optical interface 27 for the transmission of the coupling force information determined, digitalized and amplified in the measurement-data capture and evaluation unit 26, to an electronic control unit 28. The electronic control unit 28 can for example be part of an electronically controllable brake system and/or an electric drive system of the trailer vehicle 5. Data transmission between the measurement-data capture and evaluation unit 26 and the electronic control unit 28 can take place by way of a wireless, wired or glass-fiber connected data link.

The example embodiment of the two-arm support 7.1 shown in FIGS. 1 to 3 makes it possible, in particular, to determine a resultant coupling force in one direction, for example in the longitudinal direction of the vehicle. The coupling force can be a traction force or a thrust force.

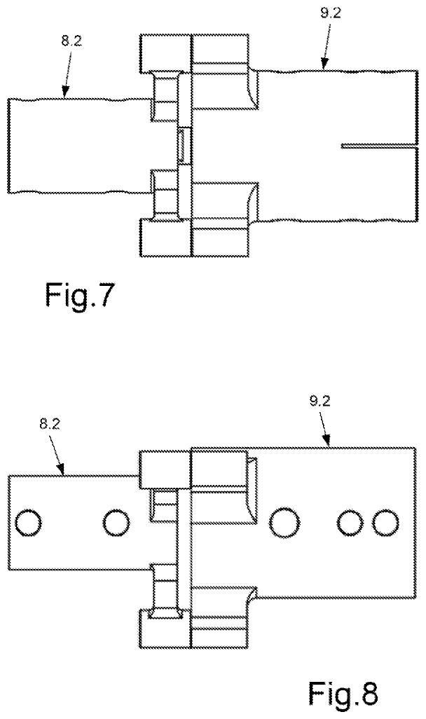

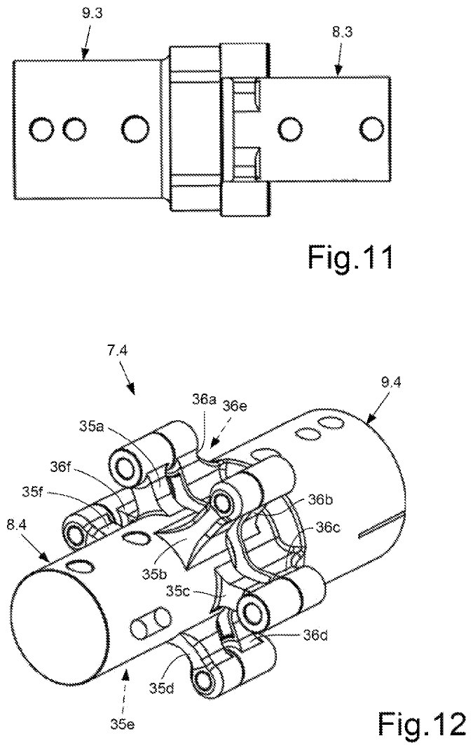

FIGS. 6 to 14 show further example embodiments, which differ essentially in the number of measurement arms arranged. Each of these further example embodiments is a symmetrical arrangement of measurement arms which enables a balanced determination of coupling forces and coupling torques in all three spatial directions. In other respects, the previous description is correspondingly applicable.

Accordingly, in FIGS. 6 to 8 three different views of a second two-part support 7.2 in the form of a three-arm arrangement are shown, namely in perspective, as seen from above, and as seen from the side. In this case a first support component 8.2 comprises three, namely a first to a third, measurement arms 30a, 30b and 30c, which are arranged relative to the respectively adjacent measurement arms offset by an angle of 120°. The three measurement arms 30a. 30b, 30c in each case carry one of the strain gauge rosettes described and generate force signals that enable a three-dimensional evaluation in the measurement-data capture and evaluation unit 26.

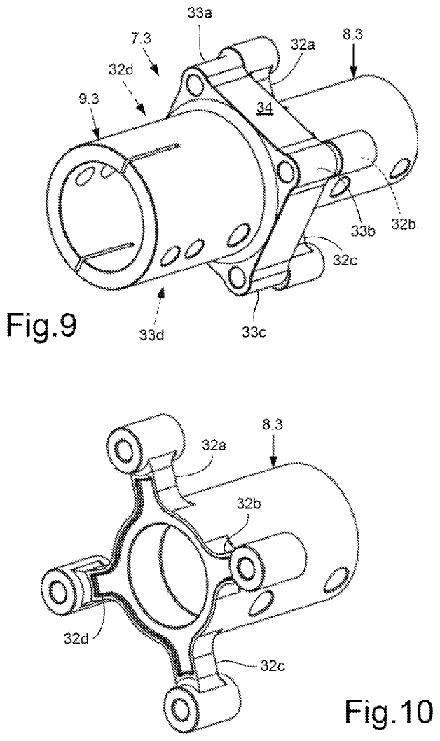

FIGS. 9 to 11 show, in perspective and viewed from the side, a third two-part support 7.3 which is in the form of a four-arm arrangement. In this, a first support component 8.3 shown in detail in FIG. 10 comprises four, namely a first to a fourth, measurement arms 32a, 32b, 32c, 32d arranged offset relative to their adjacent measurement arms by an angle of 90° in each case. A corresponding support component 9.3 has four, namely a first to a fourth, counter-arms 33a, 33b, 33c, 33d, also offset by an angle of 90° relative to one another. The four counter-arms 33a, 33b, 33c, 33d on the second support component 9.3 are largely integrated in a base-plate 34. This provides the arrangement with particularly great stability.

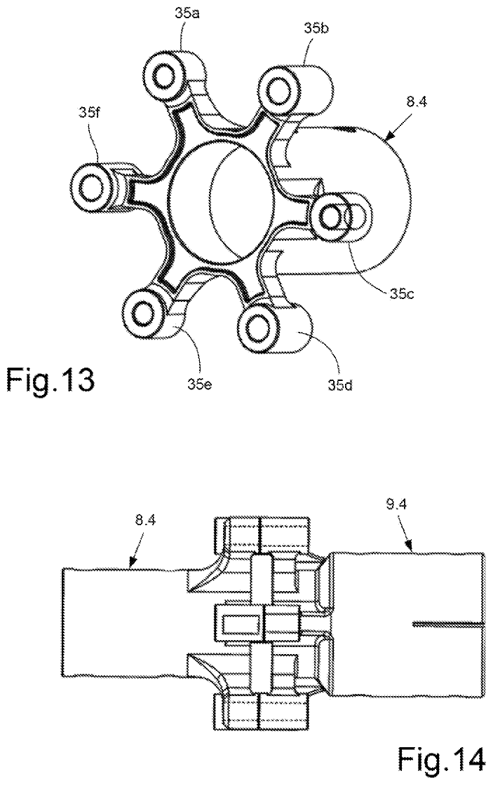

Finally, FIGS. 12 to 14 show, in perspective and viewed from the side, a fourth two-part support 7.4 in the form of a six-arm arrangement. In this case, a first support component 8.4 shown in detail in FIG. 13 comprises six, namely a first to a sixth, measurement arms 35a, 35b, 35c, 35d, 35e, 35f, each offset relative to its adjacent measurement arms by an angle of 60°. Correspondingly, a second support component 9.4 has six, a first to a sixth counter-arms 36a, 36b, 36c, 36d, 36e, 36f, also arranged offset relative to one another by an angle of 60°. The six measurement arms 35a, 35b, 35c, 35d, 35e, 35f and the six counter-arms 36a, 36b, 36c, 36d, 36e, 36f provide the six-arm arrangement of the fourth two-part support 7.4 with very great stability and force transmission capacity. At the same time the arrangement generates spatially highly resolved force signals which enable very precise determination of the coupling forces and coupling torques.

Inasmuch as the transmission of comparatively large forces via the arms of the two support components 8.4 and 9.4 seems necessary and the measurement-technological outlay and effort for a three-dimensional determination of the forces and/or torques should be kept low for reasons of cost, then with this six-arm arrangement of the fourth two-part support 7.4 only three of the measurement arms 35a, 35c, 35e offset by an angle of 120° need to be fitted with a strain gauge rosette in each case.

In conclusion, it should be pointed out that the coupling device with the features of the invention can also be connected to a one-part drawbar of a trailer vehicle. The coupling device is then fixed between the structure of the trailer vehicle and the trailer coupling of the towing vehicle, on the drawbar of the trailer vehicle. Since the two support components of the two-part support of the coupling device are only connected by their radially extending arms, these components are mechanically relatively weak in the force transfer path compared with a one-piece drawbar. When during trailer operation, that is to say when the trailer vehicle is articulated to the towing vehicle and forces are transmitted by way of the drawbar of the trailer vehicle to the towing vehicle or in the converse direction, then this results in a stretching or compression or torsion of the drawbar. This deformation of the drawbar can be measured by the measurement device of the coupling device and then evaluated, as described. Accordingly, this arrangement of a coupling device designed in accordance with the invention is particularly advantageous, since it can be fixed to any conventional trailer vehicle when geometrically adapted to the drawbar concerned.

### LIST OF INDEXES

1 Coupling device
2 Measurement device
3 Trailer coupling (ball-head coupling)
4 Towing vehicle
Trailer vehicle
6 Drawbar of the trailer vehicle
6a Coupling means on the trailer side
7.1 First two-part support (two-arm arrangement)
7.2 Second two-part support (three-arm arrangement)
7.3 Third two-part support (four-arm arrangement)
7.4 Fourth two-part support (six-arm arrangement)
8.1 First support component of the first support
8.2 First support component of the second support
8.3 First support component of the third support
8.4 First support component of the fourth support
9.1 Second support component of the first support
9.2 Second support component of the second support
9.3 Second support component of the third support
9.4 Second support component of the fourth support
Basic portion of the first support component 8.1
11 First hole in the first support component 8.1
12 Second hole in the first support component 8.1
13a First measurement arm of the first support component 8.1 (1st embodiment)
13b Second measurement arm of the first support component 8.1 (1st embodiment)
14a Eyelet of the first measurement arm 13a
14b Eyelet of the second measurement arm 13b
15a Through-bore in the eyelet of the first measurement arm 13a
15b Through-bore in the eyelet of the second measurement arm 13b
16 Basic portion of the second support component 9.1
17 First hole in the second support component 9.1
18 Second hole in the second support component 9.1
19 Third hole in the second support component 9.1
20a First counter-arm of the second support component 9.1 (1st embodiment)
20b Second counter-arm of the second support component 9.1 (1st embodiment)
21a Eyelet of the first counter-arm 20a
21b Eyelet of the second counter-arm 20b
22a Through-bore in the eyelet of the first counter-arm 20a
22b Through-bore in the eyelet of the second counter-arm 20b
23 First strain gauge rosette with three strain gauges
23a Right-hand strain gauge of the strain gauge rosette
23b Central strain gauge of the strain gauge rosette
23c Left-hand strain gauge of the strain gauge rosette
24 Second strain gauge rosette with three strain gauges
25 Six-core electric line
25.1-25.6 First core to sixth core of the electric line
26 Measurement-data capture and evaluation unit
27 Interface of the measurement-data capture and evaluation unit
28 Electronic control unit
30a-30c First to third measurement arm of the first support component 8.2 (2nd embodiment)
31a-31c First to third measurement arm of the second support component 9.2 (2nd embodiment)
32a-32d First to fourth measurement arm of the first support component 8.3 (3rd embodiment)
33a-33d First to fourth measurement arm of the second support component 9.3 (3rd embodiment)
34 Base-plate on the second support component 9.3 (3rd embodiment)
35a-35 f First to sixth measurement arm of the first support component 8.4 (4th embodiment)
36a-36f First to sixth counter-arm of the second support component 9.4 (4th embodiment)

1-9. (canceled)

10. A coupling device (1) for coupling a towing vehicle (4) to a trailer vehicle (5) of a vehicle combination, in which the towing vehicle (4) comprises a trailer coupling (3) and the trailer vehicle (5) comprises a drawbar (6) that can be coupled to the trailer coupling (3), and with a measurement device (2) for measuring forces and/or torques between the towing vehicle (4) and the trailer vehicle (5), wherein:
the measuring device (2) comprises a two-part support (7.1, 7.2, 7.3, 7.4) having an elongated first support component (8.1, 8.2, 8.3, 8.4) in the form of a sensor carrier and having, as a counterpart of the first support component (8.1, 8.2, 8.3, 8.4), an elongated second support component (9.1, 9.2, 9.3, 9.4), the first support component (8.1, 8.2, 8.3, 8.4) comprising at least two measurement arms (13a, 13b; 30a, 30b, 30c; 32a, 32b, 32c, 32d; 35a, 35b, 35c, 35d, 35e, 35f) which extend radially at a first end of the first support component (8.1, 8.2, 8.3, 8.4);
the measurement arms (13a, 13b, 30a-30c, 32a-32d, 35a-35f) of the first support component (8.1, 8.2, 8.3, 8.4) are arranged symmetrically relative to one another;
on each measurement arm (13a, 13b, 30a-30c, 32a-32d, 35a-35f) of the first support component (8.1, 8.2, 8.3, 8.4) there is arranged a strain gauge rosette (23, 23a, 23b, 23c, 24) that acts as a force sensor;
the second support component (9.1, 9.2, 9.3, 9.4) has counter-arms (20a, 20b; 31a, 31b, 31c; 33a, 33b, 33c, 33d; 35a, 35b, 35c, 35d, 35e, 35f) which extend radially at a first end of the second support component (9.1, 9.2, 9.3, 9.4) and which correspond in number and arrangement to the measurement arms (13a, 13b, 30a-30c, 32a-32d, 35a-35f) of the first support component (8.1, 8.2, 8.3, 8.4);
each of the first support components (8.1, 8.2, 8.3, 8.4) and the second support components (9.1, 9.2, 9.3, 9.4) has a first end, wherein the first end of each of the first support components faces a first end of a respective second support component, and facing first ends are configured to be connected by connecting the measurement arms (13a, 13b, 30a-30c, 32a-32d, 35a-35f) of the first support component (8.1, 8.2, 8.3, 8.4) with the respective associated counter-arms (20a, 20b; 31a-31c; 33a-33d; 35a-35f);
the first end of the first support component (8.1, 8.2, 8.3, 8.4) facing toward the towing vehicle (4) can be connected firmly to the coupling means (6a) on the trailer side;
the first end of the second support component (9.1, 9.2, 9.3, 9.4) facing toward the trailer vehicle (5) can be connected firmly to the drawbar (6); and
the measurement device (2) comprises:
a measurement-data capture and evaluation unit (26) configured to be electrically connected to the strain gauge rosettes (23, 23a, 23b, 23c, 24), the measurement device (2) arranged completely or in part on the two-part support (7.1, 7.2, 7.3, 7.4) or remotely therefrom, the measurement device (2) configured to detect and evaluate deformations of the coupling device (1) caused by forces and/or bending moments in three axial directions and that are correlated with electric signals;
an electronic circuit and/or a computer program with an algorithm by means of which, from the sensor signals captured, the coupling forces, coupling bending moments and/or components thereof acting upon the coupling device (1) can be determined according to size and direction and in sequence of time, and can be made available for further processing.

11. The coupling device according to claim 10, comprising:
a strain gauge rosette (23, 24) on a free end of each measurement arm (13a, 13b, 30a-30c, 32a-32d, 35a-35f), the strain gauge rosette (23, 24) consisting of three strain gauges (23a, 23b, 23c);
a central strain gauge (23b) orientated on each measurement arm in a direction of a notional longitudinal axis of the measurement arm (13a, 13b, 30a-30c, 32a-32d, 35a-35f); and
two strain gauges (23a, 23c) adjacent to the central strain gauge (23b) and arranged alongside the central strain gauge and at an angle from 0° and 90° relative to the central strain gauge.

12. The coupling device of claim 11, wherein the angle is from 45° to 60°.

13. The coupling device according to claim 10, wherein:
the two-part support (7.1) is in the form of a two-arm arrangement;
the first support component (8.1) comprises a radially extending first measurement arm (13a) and a radially extending second measurement arm (13b) orientated diametrically opposite the first measurement arm; and
the second support component (9.1) has two correspondingly designed and arranged counter-arms (20a, 20b).

14. The coupling device according to claim 10, wherein
the two-part support (7.2) is in the form of a three-arm arrangement;
the first support component (8.2) comprises three radially extending measurement arms (30a, 30b, 30c) with adjacent measurement arms (30a, 30b, 30c) are offset by an angle of 120°; and
the second support component (9.2) has three correspondingly configured and arranged counter-arms (31a, 31b, 31c).

15. The coupling device according to claim 10, wherein:
the two-part support (7.3) is in the form of a four-arm arrangement;
the first support component (8.3) has four radially extending measurement arms (32a, 32b, 32c, 32d with adjacent measurement arms offset by an angle of 90°; and
the second support component (9.3) has four correspondingly configured and arranged counter-arms (33a, 33b, 33c, 33d).

16. The coupling device according to claim 10, wherein:
the two-part support (7.4) is in the form of a six-arm arrangement;
the first support component (8.4) has six radially extending measurement arms (35a, 35b, 35c, 35d, 35e, 35f) with adjacent measurement arms offset by an angle of 60°; and
the second support component (9.4) has six correspondingly configured and arranged counter-arms (36a, 36b, 36c, 36d, 36e, 36f).

17. The coupling device according to claim 10, further comprising one or more strain gauge rosettes (23, 23a, 23b, 23c, 24) arranged on one or more of the counter-arms (20a, 20b; 31a-31c; 33a-33d; 36a-36f) of the second support component (9.1, 9.2, 9.3, 9.4).

18. The coupling device according to claim 11, further comprising one or more strain gauge rosettes (23, 23a, 23b, 23c, 24) arranged on one or more of the counter-arms (20a, 20b; 31a-31c; 33a-33d; 36a-36f) of the second support component (9.1, 9.2, 9.3, 9.4).

19. The coupling device according to claim 12, further comprising one or more strain gauge rosettes (23, 23a, 23b, 23c, 24) arranged on one or more of the counter-arms (20a, 20b; 31a-31c; 33a-33d; 36a-36f) of the second support component (9.1, 9.2, 9.3, 9.4).

20. The coupling device according to claim 13, further comprising one or more strain gauge rosettes (23, 23a, 23b, 23c, 24) arranged on one or more of the counter-arms (20a, 20b; 31a-31c; 33a-33d; 36a-36f) of the second support component (9.1, 9.2, 9.3, 9.4).

21. The coupling device according to claim 14, further comprising one or more strain gauge rosettes (23, 23a, 23b, 23c, 24) arranged on one or more of the counter-arms (20a, 20b; 31a-31c; 33a-33d; 36a-36f) of the second support component (9.1, 9.2, 9.3, 9.4).

22. The coupling device according to claim 15, further comprising one or more strain gauge rosettes (23, 23a, 23b, 23c, 24) arranged on one or more of the counter-arms (20a, 20b; 31a-31c; 33a-33d; 36a-36f) of the second support component (9.1, 9.2, 9.3, 9.4).

23. The coupling device according to claim 16, further comprising one or more strain gauge rosettes (23, 23a, 23b, 23c, 24) arranged on one or more of the counter-arms (20a, 20b; 31a-31c; 33a-33d; 36a-36f) of the second support component (9.1, 9.2, 9.3, 9.4).

24. A measurement device (2) for measuring forces and/or torques between a towing vehicle (4) and a trailer vehicle (5) of a vehicle combination, comprising the coupling according to claim 10.

25. A vehicle combination comprising the coupling device (1) for coupling the towing vehicle (4) to the trailer vehicle (5), and with a measurement device for measuring forces and/or torques, wherein the coupling device (1) according to claim 10.

26. The vehicle combination of claim 25, comprising a passenger car caravan.

27. The vehicle combination of claim 25, comprising a pick-up-drawbar-trailer train.
